(19) United States
(12) Patent Application Publication
(10) Pub. No.: US 2005/0225281 A1
(43) Pub. Date: Oct. 13, 2005

(54) Solar clip charging battery power system

(76) Inventor: Arnost Redl, Sarasota, FL (US)

Correspondence Address: ARNOST REDL, 4877 WILDE POINTE DRIVE, SARASOTA, FL, 34233, US

(21) Appl. No.: 10/818,533

(22) Filed: Apr. 6, 2004

(51) Int. Cl. H02J 7/00

(52) U.S. Cl. 320/101

(57) ABSTRACT

A solar clip charging battery power system that includes a solar power clip having two user adjustable power terminals that are each slidably adjustable within its own power terminal slot; and a solar powered charging circuit including multiple solar powered charging panels wired between the two user adjustable power terminals in a manner to supply charging current to the cell phone solar power clip when excess power is available from the solar powered charging panels. In a preferred embodiment, the system further includes a night light assembly powered by the adjustable power terminals when connected thereto.

### TECHNICAL FIELD

The present invention relates to rechargeable battery pack systems for cell phone systems and more particularly to a solar clip charging battery power system that includes a solar power clip having two user adjustable power terminals that are each slidably adjustable within its own power terminal slot; and a solar powered charging circuit including multiple solar powered charging panels wired between the two user adjustable power terminals in a manner to supply charging current to the cell phone solar power clip when excess power is available from the solar powered charging panels; in a preferred embodiment, the system further includes a night light assembly powered by the adjustable power terminals when connected thereto.

### BACKGROUND ART

The battery packs of cell phones are a nuisance because they seem to continuously be going dead. This is particularly aggravating when it is difficult to locate a battery charger or a new, charged battery pack. It would be desirable, therefore, to have a battery pack which could be configured to fit a large number of phones.

### GENERAL SUMMARY DISCUSSION OF INVENTION

It is thus an object of the invention to provide a solar clip charging battery power system that includes a solar power clip having two user adjustable power terminals that are each slidably adjustable within its own power terminal slot; and a solar powered charging circuit including multiple solar powered charging panels wired between the two user adjustable power terminals in a manner to supply-charging current to the cell phone solar power clip when excess power is available from the solar powered charging panels; in a preferred embodiment, the system further includes a night light assembly powered by the adjustable power terminals when connected thereto.

Accordingly, a solar clip charging battery power system is provided. The solar clip charging battery power system includes a solar power clip having two user adjustable power terminals that are each slidably adjustable within its own power terminal slot; and a solar powered charging circuit including multiple solar powered charging panels wired between the two user adjustable power terminals in a manner to supply charging current to the cell phone solar power clip when excess power is available from the solar powered charging panels; in a preferred embodiment, the system further includes a night light assembly powered by the adjustable power terminals when connected thereto.

### BRIEF DESCRIPTION OF DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a perspective view of an exemplary embodiment of the solar clip charging battery power system of the present invention mounted to a representative battery pack of a representative battery pack powered

FIG. 2 is a perspective view of a exemplary embodiment of the night light assembly of the exemplary solar clip charging battery power system of FIG. 1.

### EXEMPLARY MODE FOR CARRYING OUT THE INVENTION

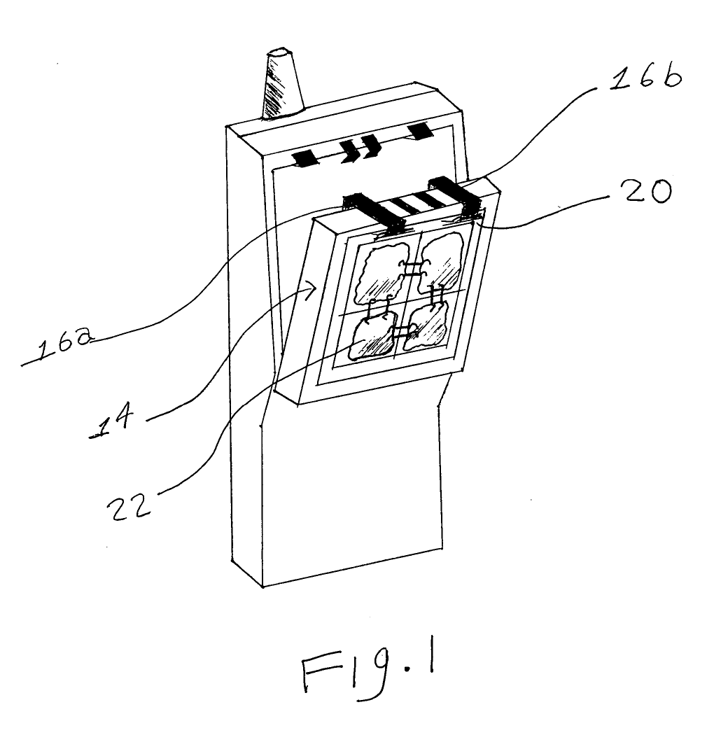

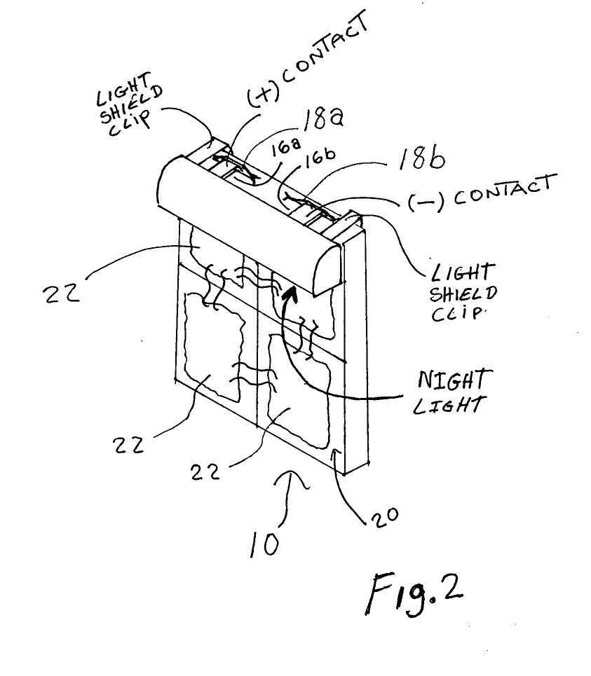

FIGS. 1 and 2 show various aspects of an exemplary embodiment of the solar clip charging battery power system of the present invention generally designated 10. Solar clip charging battery power system 10 includes a solar power clip, generally designated 14 having two user adjustable power terminals 16a,16b that are each slidably adjustable within its own power terminal slot 18a,18b; and a solar powered charging circuit, generally designated 20, including four solar powered charging panels 22 wired between the two user adjustable power terminals 16a,16b in a manner to supply charging current to the cell phone solar power clip 14 when excess power is available from the solar powered charging panels 22.

In a preferred embodiment, the system 10 further includes a night light assembly, generally designated 24, that is powered by the adjustable power terminals 16a,16b when connected thereto.

It can be seen from the preceding description that a solar clip charging battery power system has been provided.

It is noted that the embodiment of the solar clip charging battery power system described herein in detail for exemplary purposes is of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

1) A solar clip charging battery power system comprising:
a solar power clip having two user adjustable power terminals that are each slidably adjustable within its own power terminal slot;
a solar powered charging circuit including multiple solar powered charging panels wired between the two user adjustable power terminals in a manner to supply charging current to the cell phone solar power clip when excess power is available from the solar powered charging panels; and a night light assembly powered by the adjustable power terminals when connected thereto.
